(19) United States
(12) Patent Application Publication
(10) Pub. No.: US 2011/0177215 A1
(43) Pub. Date: Jul. 21, 2011

(54) COOKING APPARATUS

(76) Inventors: Charles Ogilvy Bartlett, Salisbury (GB); Andrew Peter Holman, Talbot Village (GB)

(21) Appl. No.: 12/161,432

(22) PCT Filed: Jan. 22, 2007
(86) PCT No.: PCT/GB2007/050032

§ 371 Date: Nov. 23, 2010

(30) Foreign Application Priority Data
Jan. 20, 2006 (GB) 0601165.4

(51) Int. Cl. A47J 37/06; A23L 1/01

(52) U.S. Cl. 426/143; 99/402

(57) ABSTRACT

A cooking apparatus particularly arranged for cooking toasted sandwiches and the like comprises a toasting iron including a pair of hingedly connected platens (21, 22) arranged to receive a food product to be cooked therebetween, the apparatus further comprising an oven (12) for receiving and heating the iron to cook the food product therein, wherein the iron is slidably mounted to a guide member which extends into the cooking station. The platens (21, 22) may be heated by an induction coil (60) disposed inside the oven (12).

This invention relates to cooking apparatus for toasting sandwiches and like food products.

So-called sandwich toasters are known which comprise an iron having a pair of pivotally interconnected platens which provide respective die mould-halves. The platens, when brought together, define a cavity such that a sandwich or other food product to be toasted can be placed on the lower platen and the upper platen hinged down to seal the sandwich around its edges to contain the sandwich filling.

The two halves of the iron are then locked together, whereupon the iron is inserted into an oven or grill, which applies heat to the platens and thereby cooks the sandwich constrained therebetween.

It will be appreciated that the iron becomes very hot during cooking and accordingly there are health and safety issues arising from the use of such irons, particularly in restaurants and other food outlets where workers may burn themselves or members of the public.

Another disadvantage of using toasting irons in restaurants and other food outlets is that the irons are relatively heavy and workers can become fatigued or suffer from repetitive strain injury, particularly if they are toasting large numbers of sandwiches throughout the day. In this regard, most commercial toasting ovens or grills are able to accept a plurality of irons simultaneously and as such, workers could have to handle more than one iron simultaneously.

Another disadvantage of using toasting irons is that the iron needs to be precisely located inside the oven or other cooking apparatus, otherwise the sandwich could be burnt, undercooked or unevenly cooked.

We have now devised a cooking apparatus which alleviates the above-mentioned problems.

In accordance with this invention, as seen from a first aspect, there is provided a cooking apparatus comprising a toasting iron including a pair of hingedly connected platens arranged to receive a food product to be cooked therebetween, the apparatus further comprising a cooking station for receiving and heating the iron to cook the food product therein, wherein the iron is mounted to a guide member which extends into the cooking station.

The guide member prevents the iron from being detached from the cooking apparatus and thus prevents the iron from being moved to a position where it might burn or injure someone. Also, the guide member prevents the iron from being dropped, thereby by alleviating any risk that a potentially scalding food product could spill and burn someone.

The guide member also helps to support the weight of the iron and thus the problem of fatigue and repetitive strain injury associated with handling conventional toasting irons is avoided.

Also, the guide member helps to position the iron inside the cooking station, thereby ensuring that the food product is cooked correctly and evenly.

Preferably the iron comprises a handle for moving it along the guide member into and out of the cooking station. The handle is preferably elongate.

Preferably the iron is detachable from the guide member for cleaning.

Preferably the apparatus comprises a filling station where the food product can be placed in the iron, the guide member extending from the filling station to said cooking station.

Preferably the lower platen of the cooking iron is mounted in a substantially horizontal position at said filling station, thereby facilitating the placement of the food product therein before the platens are brought together.

Preferably the cooking apparatus comprises a substantially flat work surface, which extends in a substantially horizontal plane, the guide member extending across the work surface between said filling station and said cooking station of the apparatus.

Preferably the guide member comprises a rod or bar, the iron preferably being slidably engaged with the rod or bar. Preferably the lower platen of the iron is slidably engaged with the rod or bar, the upper platen preferably being hinged to the lower platen about a rotational axis which extends perpendicular to the longitudinal axis of the rod or bar.

In order to reduce the width of the cooking apparatus, and thereby enable more toasting irons to be positioned side-by-side in the cooking station, the iron is preferably rotatable about the longitudinal axis of the rod or bar between a horizontal filling orientation and a vertical cooking orientation.

In restaurants and other food outlets, ovens and grills for heating toasting irons are either left permanently on between customers or the user has to turn the oven or grill on each time it is used. It will be appreciated that this is either wasteful or inconvenient.

Accordingly, an actuator is preferably provided in the cooking station for energising the cooking station to heat the iron, the guide member being arranged to guide the iron to a position in the cooking station where it abuts the actuator to energise a heat source.

In this manner, the cooking station is only energised when an iron is present inside the cooking station, the latter being de-energised when the iron is removed.

Preferably the cooking station comprises a plurality of sections arranged to receive respective toasting irons, each section comprising an actuator for energising only that section when an iron is present therein.

Preferably the actuator comprises a linkage, which extends from a switch into a cooking area of the cooking station, the linkage serving to isolate the switch from the heat in the cooking area.

Hitherto, toasting irons have been heated by placing them in an oven comprising gas burners or electric elements which heat the outside of the platens causing them to conduct heat to the sandwich inside. A disadvantage of this arrangement is that the transfer of heat is inefficient and the oven itself gets very hot with a large amount of energy being wasted in heating the oven housing and surrounding environment. Furthermore there is a risk that persons can burn themselves by touching the burner or element or by touching the housing. Also, the heat generated makes the cooking environment unpleasant.

Thus, in accordance with the present invention, as seen from a second aspect, there is provided a there is provided a cooking apparatus comprising a toasting iron including a pair of hingedly connected platens of a ferromagnetic material arranged to receive a food product to be cooked therebetween, the apparatus further comprising an induction coil arranged to induce an oscillating magnetic field in said platens.

The oscillating magnetic field causes power in the magnetic field to be converted to heat in the ferromagnetic platens due to hysteresis. The amount of heat produced is proportional to the area of the hysteresis loop. The magnetic field also produces eddy currents in the platens that cause resistive heating of the whole body of the ferromagnetic material. Only the platens are heated and thus the oven surface remains cool. Since there is no transfer of heat energy between the coil and the platens, less heat is lost into the air, resulting in a more efficient means of cooking, and a more agreeable cooking environment.

Preferably the apparatus comprises a pair of coils for heating respective platens of the toasting iron.

The process of toasting sandwiches and other food products containing a filling is not a cooking process. Generally the fillings are pre-cooked or are such that they can be eaten raw (vegetables for example). The bread or like material on the outside is made crisp by the application of oil and heat during the toasting process. In order to achieve this, a high temperature of approximately 250 degrees centigrade must be achieved at the surface. With certain fillings, such as cheese for example, it is essential to for the filling to reach a temperature of around 60-70 degrees centigrade for the cheese to melt or to reach a temperature that will kill any harmful bacteria that might be present in chicken for example. The control of heat and temperature and the design of the platens are critical to achieve this.

Preferably the apparatus comprises means for selecting the type of filling in the food product being toasted and means for correspondingly controlling the toasting time and/or temperature.

Preferably means are provided for monitoring the temperature of a platen. In one embodiment, said monitoring means comprises an infra red temperature sensor directed at said platen. In an alternative embodiment, said monitoring means comprises a temperature sensor mounted in thermal contact with said platen.

Preferably means are provided for monitoring the temperature of a food product contained inside the toasting iron. Preferably the said monitoring means comprises a temperature probe arranged to extend into said food product. Preferably the temperature probe extends from one of the platens and is arranged to penetrate the food product when said platens are hinged together.

Many toasted sandwiches are cooked from frozen and frozen sandwiches need to be heated slowly to bring the temperature of the filling above frozen before increasing the temperature to heat the filling and to brown the bread. Thus, the apparatus preferably comprises control means for varying the temperature of the platens in accordance with the temperature of the food product.

It will be appreciated that a temperature probe may not easily penetrate the inside of frozen sandwich. Thus in accordance with this invention, as seen from a third aspect, there is provided a frozen food product arranged for cooking in a toasting iron comprising a pair of hingedly connected platens which receive the food product to be cooked therebetween, the food product having an aperture formed therein for receiving a temperature probe extending from one of the platens when the platens are hinged together.

Embodiments of this invention will now be described by way of examples only and with reference to the accompanying drawings in which:

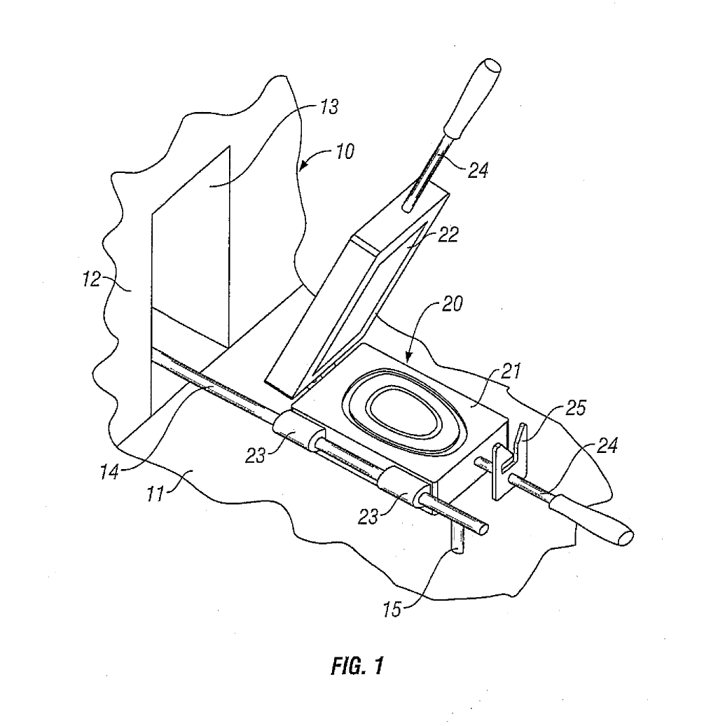

FIG. 1 is a perspective front view, from the left side and above, of a portion of a first embodiment of sandwich toasting apparatus in accordance with the present invention;

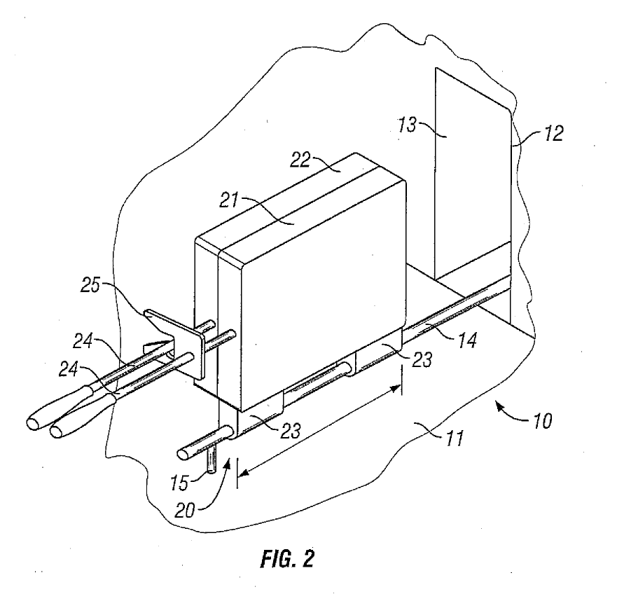

FIG. 2 is a perspective front view, from the right side and above, of the portion of the toasting apparatus of FIG. 1;

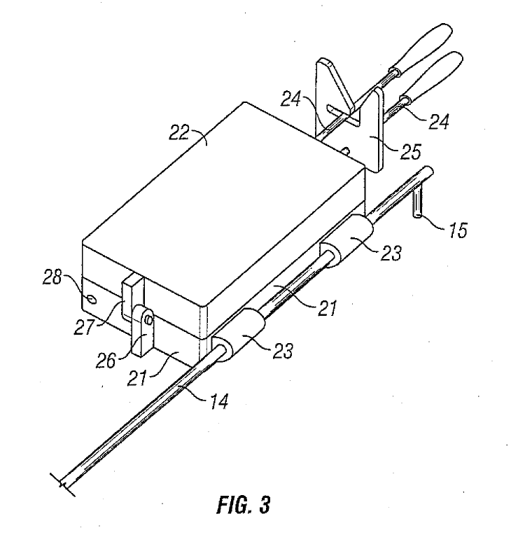

FIG. 3 is a perspective rear view, from the left side and above, of a portion of the apparatus of FIG. 1;

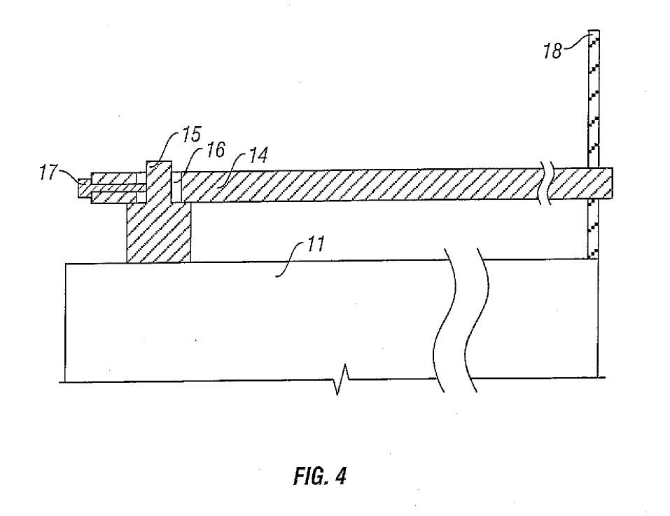

FIG. 4 is a longitudinal sectional view through a mounting rod of the apparatus of FIG. 1;

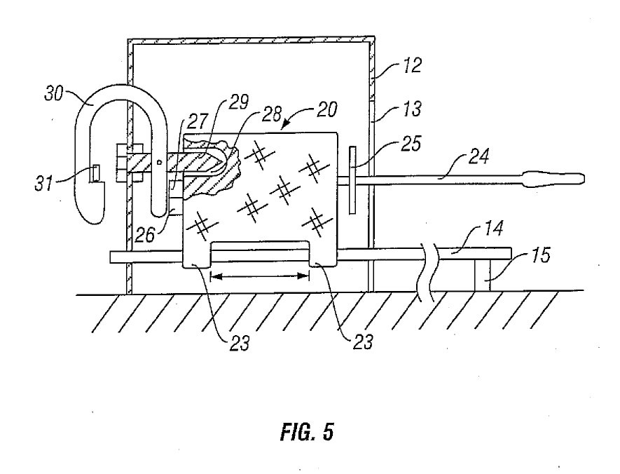

FIG. 5 is a sectional view through the apparatus of FIG. 1;

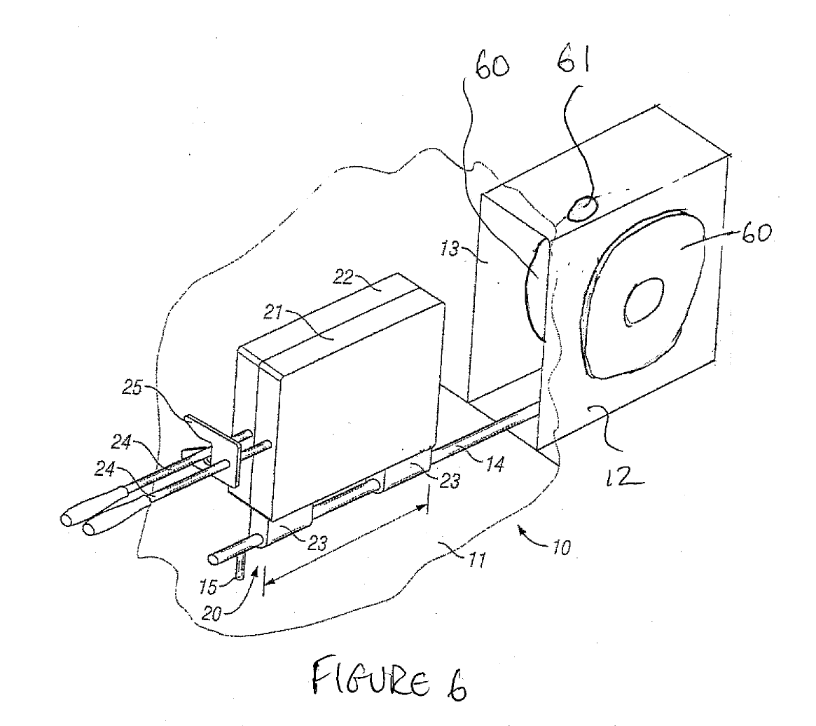

FIG. 6 is a perspective front view, from the right side and above, of a portion of a second embodiment of sandwich toasting apparatus in accordance with the present invention;

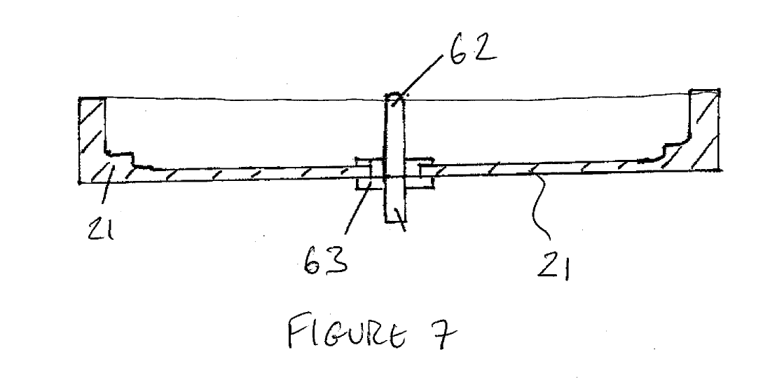

FIG. 7 is a section view through a platen of a toasting iron of the apparatus of FIG. 6; and

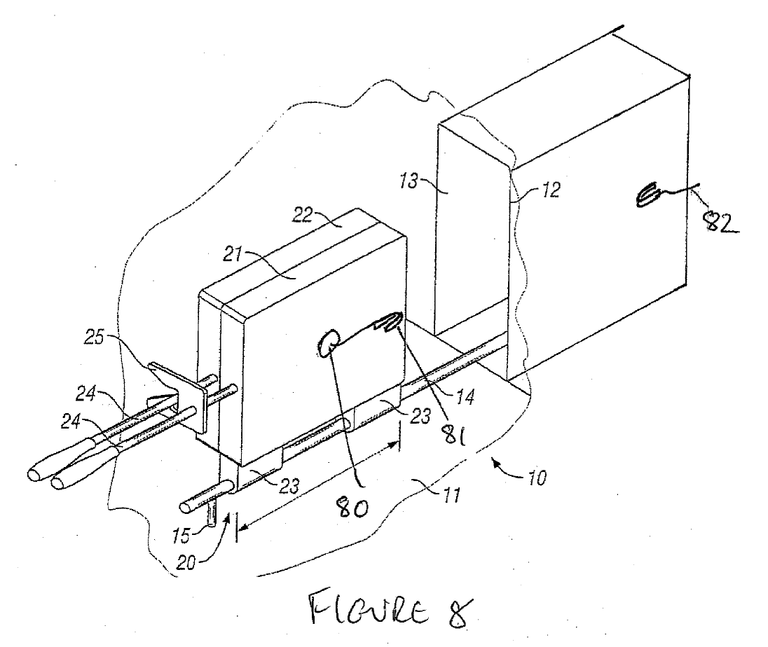

FIG. 8 is a perspective front view, from the right side and above, of a portion of a third embodiment of sandwich toasting apparatus in accordance with the present invention.

Referring to the drawings, there is shown a toasting apparatus comprising a body 10 having a housing of stainless steel or the like. The body 10 comprises a base portion 11 having a substantially flat upper surface, which extends in a horizontal plane. The body 10 further comprises an oven portion 12 extending upwardly from the rear of the base 11. The oven 12 comprises one or more sections, each having an opening 13 in the front wall thereof.

An elongate mounting rod 14 extends out of the oven 12 through the lower region of the opening 13, parallel to the top surface of the base 11. The distal end of the rod 14 is received in an aperture formed in the rear wall 18 of the oven portion 12. The proximal end of the rod 14 is mounted to a post 15, which upstands from the top surface of the base 11, as shown in FIG. 4. The post 15 comprises an upper section of reduced diameter, which extends through an aperture 16 formed in the rod 14. A grub screw 17 extends axially of the rod 14 from its proximal end into the aperture 16 and engages the post 15.

The cooking apparatus further comprises a toasting iron 20 comprising a lower platen 21 and an upper platen 22, which are hinged together. The platens are formed from cast iron or cast aluminium and are coated with a non-stick finish. Each platen 21, 22 is generally rectangular in shape, with the opposing faces of the platens 21, 22 defining mould dies for the toasted sandwich.

Projections 26, 27 respectively extend from the rear end walls of the platens 21, 22, the projections 26, 27 being interconnected by a pin, which allows the upper platen 22 to be pivoted relative to the lower platen 21. A pair of elongate handles 24 extend from the front end walls of the platens 21, 22. A pair of enlarged projections 23 extend outwardly from the left side wall of the lower platen 21, the projections 23 being formed with aligned apertures, through which the mounting rod 14 extends. The toasting iron 20 is freely slidable along the mounting rod 14. Furthermore, the toasting iron 20 can also be pivoted about the longitudinal axis of the rod 14.

Each section of the oven 12 of the apparatus comprises gas burners, electric elements or magnetic induction coils for heating the toasting iron 20, when the latter is inserted into the oven. A locating pin 29 extends from the rear wall 18 of the oven 12 into an aperture 28 formed in the rear end wall of one of the platens 21, 22 of the toasting iron 20, when the latter is inserted into the oven 12.

An arcuate actuator 30 is pivotally mounted to the locating pin 29 at the rear of the oven 12. The proximal end of the actuator 30 is arranged to abut the toasting iron 20, when the latter is inserted into the oven 12 of the apparatus. The distal end of the actuator 30 engages a switch 31, which is disposed behind the rear wall 18 of the oven portion 12 away from the heat source. Actuation of the switch 31 is arranged to energise the oven 12 for heating the toasting iron 20 when the latter is positioned inside the oven 12. When the toasting iron 20 is removed, the actuator 30 moves under the influence of gravity to a position where the switch 31 interrupts the supply of energy to that section of the oven 12 of the apparatus.

In use, the toasting iron 20 is slid forwardly along the rod 14 and pivoted downwardly into a horizontal position, until the lower platen 21 rests on the upper surface of the body portion 11 of the apparatus. The upper platen 22 is then hinged upwardly and the sandwich to be toasted placed on the upper surface of the lower platen 21.

The upper platen 22 is then pivoted downwardly and a catch 25 is provided on the lower handle 24 to engage the upper handle, thereby keeping the platens 21, 22 together.

The iron is then rotated upwardly through 90 degrees to a vertical position and simultaneously pushed rearwardly along the rod 14, so that it enters the oven 12 of the apparatus through the opening 13. Once inside the oven 12, the iron 20 locates on the pin 29, which serves to keep the iron in the correct position inside the oven portion. As hereinbefore described, the positioning of the iron 20 inside the oven 12 energises the latter to evenly heat the platens 21, 22 and thereby cook the sandwich.

After a sufficient amount of time has elapsed, the iron 20 is slid back along the mounting rod 14, thereby de-energising the oven 12. The iron 20 is then pivoted downwardly into a horizontal position, where the platens 21, 22 can be opened to allow the toasted sandwich to be removed.

The toasting iron 20 is normally constrained on the mounting rod and cannot readily be removed. However, in order to allow the iron 20 to be cleaned, the proximal end of the rod 14 can be released from the mounting post 15 by loosening the grub screw 17. The toasting iron 20 can then be detached from the rod 14.

The apparatus preferably comprises a plurality of toasting irons 20 mounted to respective rods 14, which extend from respective sections of the oven portion 12 of the apparatus. The heat source in each section is preferably operable independently of the heat sources in the other sections, so that energy is not unnecessarily wasted when one or more of the sections are not being used.

A sandwich toasting apparatus of FIGS. 1 to 5 is relatively simple and inexpensive in construction yet is able to reliably and evenly cook sandwiches without the risk of the operator becoming injured or fatigued.

Referring to FIG. 6 of the drawings, there is shown an alternative embodiment of toasting apparatus which is similar to the apparatus of FIGS. 1 to 5 and like parts are given like reference numerals. In this embodiment, a pair of flat coils 60 are mounted in a vertical plane inside the oven 12 on respective opposite sides of the opening 13. The coils 60 are connected in series and are connected to a drive circuit (not shown). In use, the toasting iron 20 is slid into the oven between the coils 60. The drive circuit is then energised either by a sensor which senses the presence of the toasting iron 20 or by actuating a control actuator on the oven. The drive circuit produces a high frequency signal (in excess of 20 kHz) which is applied to the coils 60: this generates a magnetic field that induces eddy currents in the platens 21,22. The platens 21,22 are formed of steel, iron of other ferromagnetic material which is not an ideal conductor, and thus the electrical energy is dissipated as heat as current flows through the platens 21,22.

At all times during the operation of the apparatus, the temperature of one or both platens 21,22 is monitored by a control circuit (not shown). This is achieved in a variety of ways. Firstly, the outside temperature of the platen 21 is monitored using an infra red temperature detector 61 placed adjacent the opening 13 so that it is accessible for cleaning. It is also placed in a position to which ensures that material from the sandwich cannot falls onto the lens of the sensor. Alternatively a sensor may be embedded in the material of the platen 21 to monitor the temperature of the platen. This sensor may be a thermistor or a thermocouple or other similar device. Preferably it will be embedded in non-magnetic material to prevent local heating by the induction effect.

Referring to FIG. 7 of the drawings, a probe 62 extends through the wall of the base of the platen 21, such that it will penetrate the food product when the platens 21,22 are closed. The probe 62 is supported by a thermal insulator 63. The probe 62 may be connected to the control circuit by means of mating contact terminals on the platen 21 and the oven 12. Alternatively, the probe 62 may be formed of a thermally conductive non-magnetic material such as brass, the temperature of the probe 62 being detected using infrared technology.

The control circuit comprises firmware which is programmed such that the temperature of the platens 21,22 are held at a low level for a period of time until the temperature inside the sandwich rises to ambient temperature. At this time the firmware program raises the temperature of the platens 21,22 to the toasting temperature until the temperature inside the sandwich rises to the correct value for the filling or until a maximum time is elapsed.

Referring to FIG. 8 of the drawings, there is shown an alternative embodiment of toasting apparatus which is similar to the apparatus of FIGS. 6 and 7 and like parts are given like reference numerals. In this embodiment, a temperature sensing probe 80 is attached to the platen 21 that slides on the platen rod 14. The probe 80 is electrically connected via a wire having suitable thermal properties to C-shaped spring terminal 81 located on the outside of the platen body. A corresponding C-shaped spring terminal 82 is mounted on the inside of the heating chamber and is insulated from the main body of the oven 12. The contact may be two spring contacts or a spring contact and a fixed probe that makes contact with a corresponding spring. The contact on the platen 21 is constructed to enable the platen 21 to be washed in water without damage to the probe.

The sandwich toasting apparatus of FIGS. 6 and 7 or FIG. 8 provides the following advantages:
speed of operation, including fast pre-heating of the toasting platens;
accurate temperature control of both the cooking platens and the food material that is being toasted;
control that ensures that the centre of the food material being toasted reaches the appropriate temperature required to meet a cooking hygiene or quality standard, thereby allowing successful use of pre-frozen sandwiches;
control that allows programming of variation of temperature with time to suit different types and quantities of fillings—to suit pre-frozen sandwiches and sandwiches with a frozen filling such as ice cream;
the provision of a variety of control programs that can be initiated by the operator using individual control actuators—to suit certain categories of fillings using a single control button with an appropriate symbol;
low energy consumption; and
lightweight construction.

1. Cooking apparatus comprising a toasting iron including a pair of hingedly connected platens arranged to receive a food product to be cooked therebetween, the apparatus further comprising a cooking station for receiving and heating the iron to cook the food product therein, wherein the iron is mounted to a guide member which extends into the cooking station.

2. Cooking apparatus as claimed in claim 1, in which the iron comprises a handle for moving it along the guide member into and out of the cooking station.

3. Cooking apparatus as claimed in claim 2, in which the handle is elongate.

4. Cooking apparatus as claimed in any preceding claim, in which the iron is detachable from the guide member.

5. Cooking apparatus as claimed in any preceding claim, in which the apparatus comprises a filling station, the guide member extending from the filling station to said cooking station.

6. Cooking apparatus as claimed in claim 5, in which the lower platen of the cooking iron is mounted in a substantially horizontal position at said filling station.

7. Cooking apparatus as claimed in claim 5 or 6, in which the cooking apparatus comprises a substantially flat work surface, which extends in a substantially horizontal plane, the guide member extending across the work surface between said filling station and said cooking station of the apparatus.

8. Cooking apparatus as claimed in any preceding claim, in which the guide member comprises a rod or bar.

9. Cooking apparatus as claimed in claim 8, in which the iron is slidably engaged with the rod or bar.

10. Cooking apparatus as claimed in claim 9, in which the lower platen of the iron is slidably engaged with the rod or bar.

11. Cooking apparatus as claimed in any of claims 8 to 10, in which the upper platen is hinged to the lower platen about a rotational axis which extends perpendicular to the longitudinal axis of the rod or bar.

12. Cooking apparatus as claimed in any of claims 8 to 11, in which the iron is rotatable about the longitudinal axis of the rod or bar between a horizontal filling orientation and a vertical cooking orientation.

13. Cooking apparatus as claimed in any preceding claim, in which an actuator is provided in the cooking station for energising the cooking station to heat the iron, the guide member being arranged to guide the iron to a position in the cooking station where it abuts the actuator to energise a heat source.

14. Cooking apparatus as claimed in any claim 13, comprising a plurality of sections arranged to receive respective toasting irons, each section comprising an actuator for energising only that section when an iron is present therein.

15. Cooking apparatus as claimed in any preceding claim, in which the actuator comprises a linkage, which extends from a switch into a cooking area of the cooking station.

16. Cooking apparatus as claimed in any preceding claim, in which the platens are formed of a ferromagnetic material, the apparatus further comprising an induction coil arranged to induce an oscillating magnetic field in said platens.

17. Cooking apparatus comprising a toasting iron including a pair of hingedly connected platens of a ferromagnetic material arranged to receive a food product to be cooked therebetween, the apparatus further comprising an induction coil arranged to induce an oscillating magnetic field in said platens.

18. Cooking apparatus as claimed in claim 17, comprising a pair of coils for heating respective platens of the toasting iron.

19. Cooking apparatus as claimed in claim 17 or 18, comprising means for selecting the type of filling in the food product being toasted and means for correspondingly controlling the toasting time and/or temperature.

20. Cooking apparatus as claimed in any of claims 17 to 19, comprising means for monitoring the temperature of a platen.

21. Cooking apparatus as claimed in claim 20, in which said monitoring means comprises an infra red temperature sensor directed at said platen.

22. Cooking apparatus as claimed in claim 20, in which said monitoring means comprises a temperature sensor mounted in thermal contact with said platen.

23. Cooking apparatus as claimed in any of claims 17 to 22, comprising means for monitoring the temperature of a food product contained inside the toasting iron.

24. Cooking apparatus as claimed in claim 23, in which said monitoring means comprises a temperature probe arranged to extend into said food product.

25. Cooking apparatus as claimed in claim 24, in which the temperature probe extends from one of the platens and is arranged to penetrate the food product when said platens are hinged together.

26. Cooking apparatus as claimed in any of claims 23 to 25, comprising control means for varying the temperature of the platens in accordance with the temperature of the food product.

27. A frozen food product arranged for cooking in a toasting iron comprising a pair of hingedly connected platens which receive the food product to be cooked therebetween, the food product having an aperture formed therein for receiving a temperature probe extending from one of the platens when the platens are hinged together.
